(19) United States
(12) Patent Application Publication
(10) Pub. No.: US 2026/0100177 A1
(43) Pub. Date: Apr. 9, 2026

(54) Tone circuits with fret-like steps fitted to individual guitar pickups

(71) Applicant: Donald L. Baker, Tulsa, OK (US)

(72) Inventor: Donald L. Baker, Tulsa, OK (US)

(21) Appl. No.: 19/012,191

(22) Filed: Jan. 7, 2025

Related U.S. Application Data
(63) Continuation of application No. 18/906,082, filed on Oct. 3, 2024, now abandoned.

(51) Int. Cl. G10H 3/18

(52) U.S. Cl. CPC G10H 3/182

(57) ABSTRACT

This invension discloses five embodiments of a switched resistor-capacitor tone-control circuit, placed at the output of an electric guitar or guitar pickup, such that the bandwidth of the output changes in fret-like logarthmic steps in frequency. This replaces potentiometer-capacitor tone circuits which usually have areas of little change in tone/timbre, intersperced with rapid changes in tone/timbre. Unlike standard tone pots, it can be easily matched to individual pickups.

### CROSS-REFERENCE TO RELATED APPLICATIONS

This applications continues U.S. NP patent application Ser. No. 18/906,082, D. L. Baker, 2024 Oct. 16, Fitting tone circuits to individual guitar pickups

### COPYRIGHT AUTHORIZATION

A large portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

© 2024-2025, Donald L. Baker dba android originals LLC, Tulsa OK, claiming copyright on this entire work, excepting any drawings taken from other sources of prior art.

### PRIOR ART

U.S. Pat. No. 2,784,631, C. L. Fender, 1957 Mar. 12, Tone control for stringed instruments
U.S. Pat. No. 10,380,986, D. L. Baker, 2019 Aug. 13, Means and methods for switching odd and even numbers of matched pickups to all humbucking tones
U.S. NP patent application Ser. No. 18/906,082, D. L. Baker, 2024 Oct. 16, Fitting tone circuits to individual guitar pickups (continuation)

### BACKGROUND AND SUMMARY OF THE INVENTION

This invention proceeds from directly from U.S. Non-Provisional patent application Ser. No. 18/906,082, Fitting tone circuits to individual guitar pickups, Baker, 2024 Oct. 16. One industry source can be quoted as saying that the kind of tone pot in that invention will never be made, because it will cost more than the $5 to $10 that guitar makers expect to pay for tone pots. This may very well be true. If so, then another approach with similar results must be invented.

If one cannot get or have made a continuously variable potentiometer with a specific resistance curve made especially for tone circuit for a specific pickup, then the next viable alternative is to use either a series switched resistances or switched capacitances, wherein the switched step change of resistance or capacitance in an electric guitar “tone circuit” causes a step change in the frequency bandwidth of the pickup which the tone circuit allows to the output of an electric guitar. Because human hearing is logarithmic in both amplitude and frequency, the step changes in the bandwidth should be also, to make the changes sound uniform.

Using the same math and very similar spreadsheet methods as NPPA 18/906,082 makes it possible to choose the right steps in capacitance or resistance. It only remains to decide how large the steps should be, and at what minimum (or low) bandwidth they should start. For the use of musicians, it is convenient to express this in terms of frets, by converting the bandwidth frequency to an equivalent fret number, and vice versa. For example, it seems to work well in experiments on a prototype guitar to set the minimum bandwidth to the 18th fret of the high E string (string 1) of a standard EBCGBE guitar tuning, on a common 25.5″ six-string guitar of 21 or 22 frets, with a fret step in bandwidth of 3 frets. This happens to start at 932.2 Hertz (Hz or cycle per second) and increase in steps of 2^{1/4}=1.189207115 times the previous bandwidth. While other choices are possible, and even preferable for other stinged instruments, that will be the example presented here.

This inventor could not find any prior patents that do so, in no small part because the available patent search tools either produce too many irrelevant results, or are simply difficult to use. Sorry about that. Gretsch Guitars has a “Tone Switch Circuit”, found in the Support/Basic Control Guide page of their web site. It is a three-way switch, commonly called a “mud switch”, with two capacitors, 0.012 uF and 0.0039 uF, in which the center throw does not connect to either one. It does not have a tone pot separate from the pickup volune pots.

Here, the preferred tone circuit has separate switched tone circuits for each pickup which has a tone circuit. For a 3-coil guitar, say three P-90s as on the prototype where this invention was developed, the middle and neck pickups have tone circuits. But the bridge does not, since the bridge is the treble pickup, and a tone circuit adds effective capacitance to the pickup which always cuts down the higher frequencies.

### BRIEF DESCRIPTION OF DRAWINGS

FIG. 1—A lumped-parameter circuit diagram of an electromagnetic guitar pickup, with a string signal voltage source, Vp, a coil inductance, Lp, a coil resistance, Rp, a coil-winding capacitance, Cp, and an output voltage above ground, Vo; FIG. 4 in U.S. Ser. No. 18/906,082.

FIG. 2—The pickup circuit in FIG. 1, without a string signal, driven by an AC source voltage, Vs, through a large resistor, Rs, to produce an effective current drive into the pickup at voltage point Vo; FIG. 7 in U.S. Pat. No. 18,906,082.

FIG. 3—The pickup circuit in FIG. 1 with a parallel “tone circuit” comprising of a resistance, Rt, and a capacitance, Ct; FIG. 8 in U.S. Ser. No. 18/906,082.

FIG. 4—FIG. 5 from U.S. NP patent application Ser. No. 18/906,082 (Baker, 2024), showing the bandwidth frequency curves for a pickup with Lp=1.77 H, Rp=5047 ohms, Cp=308 pF and Ct=22 nF for Rt=1 ohm to 100 Meg-ohms, demonstrating low and high frequency resonant peaks.

FIG. 5—An example of the first embodiment of the invention, where a tone circuit in parallel with a guitar or pickup output has an optional resistor, R1, switched in series with tone capacitors C1 to C11 on a 1-pole, 12 pole switch, leaving the pole on the other side of C11 from C10 open and unconnected.

FIG. 6—Example bandwidth curves for the first embodiment, derived by software circuit simulation from Table 4, for a typical P-90 pickup with optional resistor R1=6800 ohms, and 11 of 12 throws of a 1-pole, 12-throw switch placing values of Ct=20 nF down to 0.39 nF, with the 12th throw an open circuit, producing 11 increasing bandwidths in approximate 3-fret steps.

FIG. 7—An example of the second embodiment of the invention, where a tone ciruit in parallel with a guitar or pickup output has a 1-pole, 12-throw switch puts an increasing resistance, Rti, in series with a tone capacitor, Ct, where Rti is the sum of the switched resistors, Ri, with the last throw being an open circuit, preferred for tone circuits that de-emphasize resonant peaks, suitable for neck or middle pickups, but perhaps not a bridge pickup.

FIG. 8—Example bandwidth curves for the second embodiment, derived by software circuit simulation from Table 7, for a typical P-90 pickup with a tone capacitor, Ct=20 nF, and values of Ri=5760 to 11,000 ohms, producing Rti from their series sum, Rti=5760 to 72,770 ohms, with the last switch position an open circuit, labeled Rnone.

FIG. 9—Shows an example tone switching circuit of a third embodiment, with a 1-pole, 12-throw switch moving up a capacitance series ladder of values Ci, I=1 to 12, set to produce a log change in output bandwidth with switch position, with an end position being empty to allow the pickup its full natural bandwidth, preferred for tone circuits that emphasize resonant peaks, suitable for a middle or bridge pickup, but perhaps not a neck pickup.

FIG. 10—Shows an example tone switching circuit of a fourth embodiment, with a 1-pole, 12 throw switch moving up a set of Ri+Ci circuits, I=1 to 11, set to produce a log change in output bandwidth with switch position, designed to produce some desired envelope of resonant peaks, reduced from those of the first embodiment, with an end switch position left open to allow the pickup it full natural bandwidth.

FIG. 11—Shows an example tone switching circuit of a fifth embodiment, with a 1-pole, 12 throw switch moving up a set of resistors, Ri, I=1 to 11, in series with a tone capacitor, Ct, those circuits set to produce a log change in output bandwidth with switch position, with the last throw being an open circuit to allow the pickup it full natural bandwidth.

### DETAILED DESCRIPTION OF THE INVENTION

### Tone Circuit Background Math

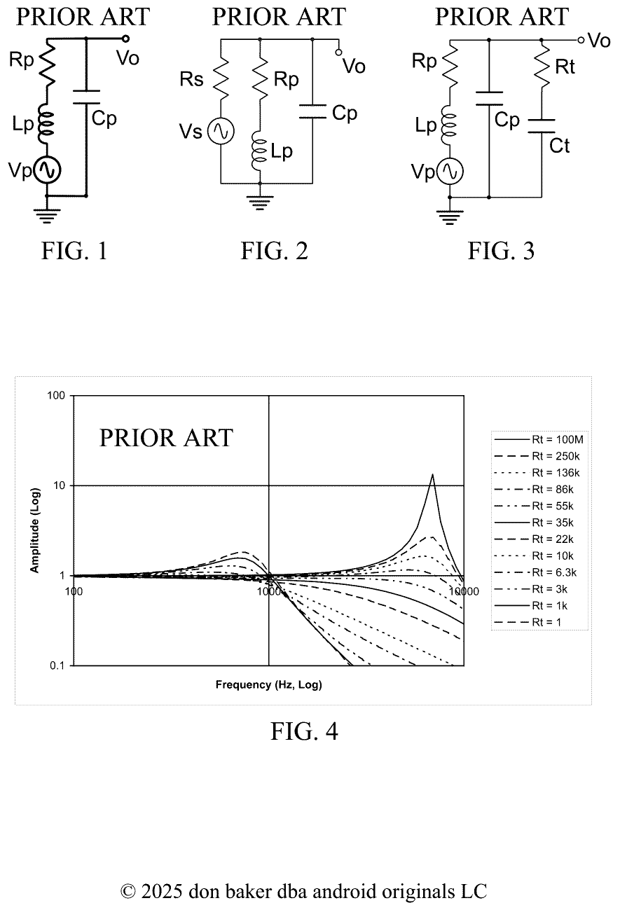

Here it one must repeat some of the development in U.S. NP patent application Ser. No. 18/906,082 so that this application may stand on its own. FIG. 1 shows the lumped-parameter circuit of an electromagnetic guitar pickup with a signal source, Vp, a coil inductance, Lp, a coil resistance, Rp, an inter-winding coil capacitance, Cp, and an output voltage, Vo. The common units of measure are inductance in Henries, H, resistance in Ohms, where kilo-ohms is commonly abreviated to “k”, capacitance in Faradays, F, and volts, V, all with various standard prefixes to indicate magnitude.

The inductance and resistance of a pickup can be measured directly with a digital RLC meter, but the pickup coil inter-winding capacitance is so small that it has to be measured by inference. FIG. 2 shows a large series resistance, Rs, on the order of meg-ohms (M-ohms) in series with an external voltage source, Vs, and the pickup, Lp, Rp and Cp. The voltage output, Vo, becomes a maximum as the frequency of Vs matches the resonant frequency of the pickup, Fp. Math 1 shows the calculation for Cp from Lp, Rp and Fp, where Wp is the frequency in radian/sec.

$$Cp = \frac{1}{Wp \sqrt{{Lp}^{2} {Wp}^{2} + {Rp}^{2}}} , where Wp = 2 π Fp \qquad Math 1$$

In the pickup circuit in FIG. 1, Vp is the pickup voltage created within it by the motion of the guitar strings over it, and Vo is the output voltage. As the frequency of the string signal increases from say 10 Hz (10 cycles per second), it will be relatively constant over a range of lower audio frequencies. As it reaches the frequency of resonance between Lp, Rp and Cp, it generally peaks, then falls off rapidly with frequency, since Cp effectively shorts out the signal a high audio frequencies. Classical signal theory defines “bandwidth” at the frequency, Fb, where the output, Vo, is ½ of Vp. Math 2 shows this calculation, where Wb is the bandwidth frequency in radians/sec.

$$W b = \frac{\sqrt{2 Cp ( - {Rp}^{2} Cp + 2 Lp + \sqrt{{Rp}^{4} {Cp}^{2} - 4 {Rp}^{2} LpCp + 16 {Lp}^{2}}}}{2 LpCp} \qquad Math 2$$

$$Fb = \frac{W b}{2 π}$$

FIG. 3 shows the lumped-parameter circuit of an electromagnetic guitar pickup from FIG. 1 in parallel with a tone circuit with a tone resistor, Rt, and a tone capacitance, Ct. Because the tone circuit adds effective capacitance in parallel with the pickup, the added capacitance tends to short out the higher frequencies and lower the bandwidth from Fb.

$$\frac{Vo}{Vp} = g = \sqrt{\frac{{Rt}^{2} {Ct}^{2} {w}^{2} + 1}{\begin{matrix}\begin{matrix}{( LpCpRtCt )}^{2} {w}^{6} + ( {( RpCpRtCt )}^{2} - 2 {LpCpRt}^{2} {Cr}^{2} + \\ {{Lp}^{2} ( Cp + Ct )}^{2} ) {w}^{4} + ( {{Rp}^{2} ( Cp + Ct )}^{2} + ( 2 RpRt + {Rt}^{2} ) {Ct}^{2} -\end{matrix} \\ 2 Lp ( Cp + Ct ) ) {w}^{2} + 1\end{matrix}}} \qquad Math 3$$

Math 3 shows the equation for Vo/Vp, where w=2*Pi*F, for the pickup plus tone circuit in FIG. 3. It addresses only the output signal amplitude, not the phase relative to the input signal. Adding a tone circuit, Rt and Ct, means that the value of g=½ defines the pickup-tone-circuit bandwidth, Wbt, and that Wbt<Wb the natural bandwidth.

$${\frac{Vo}{Vp} \vert}_{Rt = 0} = \frac{1}{\sqrt{{{Lp}^{2} ( Cp + Ct )}^{2} {w}^{4} + ( {{Rp}^{2} ( Cp + Ct )}^{2} - 2 Lp ( Cp + Ct ) ) {w}^{2} + 1 )}} \qquad Math 4$$

$${\frac{Vo}{Vp} \vert}_{Rt = 0} = \frac{1}{2} \to Ct + Cp = \frac{Lpw + \sqrt{4 {Lp}^{2} {w}^{2} + 3 {Rp}^{2}}}{( {Lp}^{2} {w}^{2} + {Rp}^{2} ) w}$$

Setting Rt=0 in Math 3 produces Math 4. Setting Vo/Vp=½ in Math 4 and solving for Ct+Cp produces Math 5. If w is set to the desired bandwidth equivalent to the desired fret steps, then Ct can be derived for those steps.

$$Rt = \frac{[ RpCt \cdot w \pm {[ \begin{matrix}\begin{matrix}\begin{matrix}\begin{matrix}- {Lp}^{4} {{Cp}^{2} ( Cp + Ct )}^{2} {w}^{8} \\ - 2 {Lp}^{2} Cp ( Cp + Ct ) ( {Rp}^{2} Cp ( Cp + Ct ) -\end{matrix} \\ Lp ( 2 Cp + Ct ) ) {w}^{6}\end{matrix} \\ + [ \begin{matrix}\begin{matrix}- {Rp}^{4} {{Cp}^{2} ( Cp + Ct )}^{2} \\ + 2 {LpRp}^{2} Cp ( Cp + Ct ) ( 2 Cp + Ct )\end{matrix} \\ + {Lp}^{2} ( 2 {Cp}^{2} + 2 CpCt + 3 {Ct}^{2} )\end{matrix} ] {w}^{4}\end{matrix} \\ + [ \begin{matrix}\begin{matrix}+ 2 {Rp}^{2} ( 3 {Cp}^{2} + 3 CpCt + 2 {Ct}^{2} ) \\ - 6 Lp ( 2 Cp + Ct )\end{matrix} \\ - 9\end{matrix} ] {w}^{2}\end{matrix} ]}^{1 / 2} ]}{- Ct \cdot w ( {Lp}^{2} {Cp}^{2} {w}^{4} + ( {Rp}^{2} {Cp}^{2} - 2 LpCp ) {w}^{2} - 3 )} \qquad Math 6$$

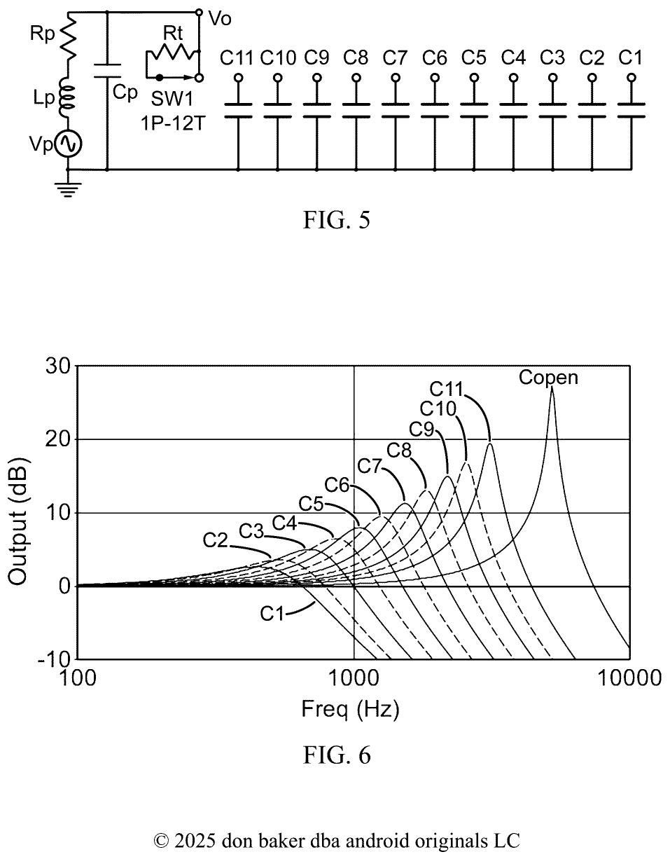

Math 3 can be solved at g=½ for Rt, but as Math 6 shows, the result is complicated. If w is set to the desired bandwidth equivalent to the desired fret steps, then for a given Ct, Rt can be determined at each step from Math 6. FIG. 4 (FIG. 5 in U.S. Ser. No. 18/906,082) shows one typical response of the bandwidth of a pickup to changing Rt. For Rt near zero, it starts from a low-frequency resonant peak, related to Cp+Ct, which diminishes with increasing Rt, then flattens out. As Rt goes toward inifinite resistance, it reaches the resonant peak associated with Cp alone, which is different for every pickup. As U.S. Ser. No. 18/906,082 shows, the low-frequency resonant peak, which is much smaller than the high-frequency peak, can be bypassed by starting Rt at a value near the resistance of the pickup, Rp. Whether or not this is perferable will depend upon the tastes of the musician using the instrument. It can be done both ways.

### Using Fret-Like Steps to Express Pickup/Tone Circuit Bandwidth

In standard EADGBE tuning, from string 6 (low-E) to string 1 (high-E), the open-fret frequency of string 1 is 329.6 Hz, and the fret frequency of string 1 fretted at the 12th fret is 2 times 329.6 Hz=659.2 Hz. Every n+1 fret frequency, Fₙ₊₁, relates to the frequency of the previous fret, Fₙ, by Math 7.

$${F}_{n + 1} = {2}^{1 / 12} \cdot {F}_{n} \qquad Math 7$$

In the prototype guitar used to develop this invention, it seemed to work well to set Ct, according to Math 5, to produce a bandwidth equivalent to the 18th fretted string frequency of 932.2 Hz. While one might expect this to silence string 1 fretted notes for higher frets up to fret 21 (1108.6 Hz), this was not very noticable.

One found it impractical and not commercially viable to create the custom tone pots (invented in U.S. Ser. No. 18/906,082) for tone circuits. This invention uses common 1-pole, 12-throw switches instead to change either Rt or Ct or both to produce changes in tone-circuit bandwidth. Other switches are possible, but these switches are preferred because of their low price and common availability. One must next decide how many equivalent frets in bandwidth to use per switch position. For the P-90 pickups in the prototype guitar used to develop this invention, bandwidth steps of 3 frets seemed to work well. An average P-90 pickup has a resonant frequency of about 9073 Hz (Table 5 in U.S. Ser. No. 18/906,082). The resonant frequencies of the 11 example pickups in U.S. Ser. No. 18/906,082 ran from 6217 Hz to 14,675 Hz. Human ears have a peak response between about 1000 to 2000 Hz. So it is possible that any bandwidth changes above 5000 Hz may not be very noticeable. But that remains to be determined for individual musicians. Table 1 shows the equivalent string-1 bandwidths for virtual frets from 18 to 54, with 11 in bold from 18 to 48 in 3-fret steps.

TABLE 1
Bandwidth frequencies for virtual frets from 18 to 54 on string 1 in
EBCGBE tuning, in bold for 11 values from 18 to 48 at 3-fret steps.

| Fret | Hz | Fret | Hz | Fret | Hz |
|---|---|---|---|---|---|
| 18 | 932.2 | 30 | 1864.5 | 42 | 3729 |
| 19 | 987.7 | 31 | 1975.4 | 43 | 3950.7 |
| 20 | 1046.4 | 32 | 2092.8 | 44 | 4185.7 |
| 21 | 1108.6 | 33 | 2217.3 | 45 | 4434.6 |
| 22 | 1174.6 | 34 | 2349.1 | 46 | 4698.2 |
| 23 | 1244.4 | 35 | 2488.8 | 47 | 4977.6 |
| 24 | 1318.4 | 36 | 2636.8 | 48 | 5273.6 |
| 25 | 1396.8 | 37 | 2793.6 | 49 | 5587.2 |
| 26 | 1479.9 | 38 | 2959.7 | 50 | 5919.4 |
| 27 | 1567.9 | 39 | 3135.7 | 51 | 6271.4 |
| 28 | 1661.1 | 40 | 3322.2 | 52 | 6644.3 |
| 29 | 1759.9 | 41 | 3519.7 | 53 | 7039.4 |
| 30 | 1864.5 | 42 | 3729 | 54 | 7458.0 |

In this setup, the 12th throw has no connection to the tone circuit, allowing the full bandwidth of the pickup to shine through. So for a P-90 pickup, from the 48^{th} fret to full bandwidth, the bandwidth jumps from 5273.6 Hz to about 9073 Hz. In practice, many players find that much bandwidth too bright, and switch in some capacitance to the make the output warmer. Table 2 show 11 bandwidth frequencies for 4-fret steps, starting from fret 18.

TABLE 2
Eleven values of bandwidth in 4-fret steps from 18 to 58

| Fret | Hz |
|---|---|
| 18 | 932.2 |
| 22 | 1174.6 |
| 26 | 1479.9 |
| 30 | 1864.5 |
| 34 | 2349.1 |
| 38 | 2959.7 |
| 42 | 3729.0 |
| 46 | 4698.2 |
| 50 | 5919.4 |
| 54 | 7458.0 |
| 58 | 9396.5 |

With this choice, the step from the last controlled bandwidth to full P-90 pickup bandwidth will be at the 10^{th} step, as with a 54th fret, from about 7458 Hz to about 9073 Hz. The choice of which is preferable will depend again on the musician's choice and can be much more easily customized, both to individual pickups and to musicians, than with using linear or “audio” tone pots. Such pots not only have a small and fixed number of tapers and total resistance values, but also typically have a wide range of tolerances. Switched resistors or capacitors can easily be set more precisely to match individual pickups.

The 1-pole, 12-throw switch used here is not the only choice. Rotary switches also go up to 1-pole, 24-throw, allowing either finer resolution in fret steps, or more choices of fret steps, for a higher price. However, any switch chosen should be “shorting” or “make before break”. If the switch in this invention is “non-shorting” or “break before make”, then in between steps, the bandwidth will shoot up to the maximum bandwidth, potentially causing an audible high-frequency squawk in the output. A shorting switch will briefly lower the bandwidth between steps, but will be much less noticeable.

TABLE 3
Eleven example pickups from U.S. 18/906,082, with inductance,
Lp, resistance, Rp, capacitance, Cp, and natural bandwidth,
Fb; those with “Avg” are averaged over three pickups
on hand; the rest come from one pickup on hand

| | Lp | Rp | Cp | Fb |
|---|---|---|---|---|
| Pickup | (H) | (ohms) | (pF) | (Hz) |
| Avg F Squier SC | 1.77 | 5047 | 308 | 11807 |
| Avg PU-6192 Filtertron HB | 2.17 | 4700 | 190 | 13570 |
| PU-6459N Vintage Chrome HB | 2.09 | 5650 | 169 | 14675 |
| Avg PU-6430 Hofner HB | 3.29 | 6120 | 179 | 11342 |
| Avg PU-0418 P-90 SC | 4.3 | 6100 | 215 | 9073 |
| Avg PU-0436 Soap Bar SC | 4.39 | 6130 | 216 | 8957 |
| Avg PU-6459 Vintage Chrome HB | 2.82 | 8200 | 126 | 14612 |
| F Squier HB | 4.19 | 9900 | 184 | 9930 |
| Avg ML-533 Dual Rail HB | 7.06 | 12000 | 278 | 6217 |
| Avg PU-6193 Jazzmaster SC | 6.12 | 11983 | 229 | 7354 |
| PU-0423 Economy HB | 7.96 | 12010 | 192 | 7053 |
| MAX= | 7.96 | 12010 | 308 | 14675 |
| MIN= | 1.77 | 4700 | 126 | 6217 |

### A First Embodiment—Switched Ci with a Single Optional Rt

FIG. 5 shows a first embodiment, a pickup as in FIG. 1, with a switched-capacitor tone circuit in parallel with it, using a 1-pole, 12-throw rotary or digital switch, an optional tone resistor, Rt, and 11 capacitors, all set to produce a fret-like long change in output bandwidth. As shown, if the switch is rotary, then the direction of the throws which reduce bandwidth can be either clockwise or counter-clockwise, depending on the musician's preference. Capacitor C1 is the largest, connected to throw 1, with capacitors C2 to C11, connected to throws 2 to 11 respectively, becoming progressively smaller according to the desired fret steps in bandwidth. The resistor Rt can be either a short or low value, on the order of the pickup resistance, Rp, without overly affecting the results of Math 5. Connecting it to throw 12 is just a handy way to mount it on a rotary mechanical switch, with the high output of the pickup, Vo, mounted to throw 12, as well. Other equivalent configurations are possible. Capacitor C1 produces the lowest output bandwidth at throw 1, and throw 12 produces the full natural bandwidth of the pickup. The switch used can be any number of throws, two or more, with or without a stop between the first and last throws. It can be a rotary mechanical switch or a digitally-controlled analog solid state semiconductor switch, or some other electrical equivalent. As noted before, it should be a shorting switch. So long as Rt is on the order of 2 times Rp or less, Math 5 will work well enough to calculate the approximate values of Ci, I=1 to n, n>1. Otherwise, the math used needs to be derived taking Rt into account in the bandwidth. Table 4 shows an example set of switched capacitors, using the P-90 pickup from Table 3.

TABLE 4
Design & Practical C1 to C11 = Ct in FIG. 5, from Math 5 for P-90
pickup, with 3-fret steps, using available values from a ceramic capacitor
kit, with 3-fret steps accurate to about plus or minus 0.4 fret

| | | | | Prac- | | Prac- | |
|---|---|---|---|---|---|---|---|
| | Design | | Design | tical | | tical | Del- |
| Cap | Fret | Hz | Ct(nF) | Ct(nF) | F(Hz) | Fret | Fret |
| C1 | 18 | 932.2 | 19.27 | 20 | 914.6 | 17.7 | |
| C2 | 21 | 1108.6 | 13.73 | 15 | 1060 | 20.2 | 2.6 |
| C3 | 24 | 1318.3 | 9.74 | 10 | 1300.8 | 23.8 | 3.5 |
| C4 | 27 | 1567.8 | 6.87 | 6.8 | 1575.2 | 27.1 | 3.3 |
| C5 | 30 | 1864.4 | 4.81 | 4.7 | 1886.2 | 30.2 | 3.1 |
| C6 | 33 | 2217.2 | 3.35 | 3.3 | 2233.9 | 33.1 | 2.9 |
| C7 | 36 | 2636.7 | 2.31 | 2.2 | 2698.3 | 36.4 | 3.3 |
| C8 | 39 | 3135.5 | 1.58 | 1.5 | 3204.5 | 39.4 | 3 |
| C9 | 42 | 3728.8 | 1.05 | 1 | 3809.4 | 42.4 | 3 |
| C10 | 45 | 4434.3 | 0.68 | 0.68 | 4440.3 | 45 | 2.7 |
| C11 | 48 | 5273.3 | 0.42 | 0.39 | 5403 | 48.4 | 3.4 |

This can be done in similar fashion for any electromagnetic guitar pickup. FIG. 6 shows the results of a circuit simulation of this circuit, and Table 5 shows the approximate bandwidths that the circuit simulation produced.

Note that FIG. 6 advances the bandwidth in 11 fret-like steps from a low bandwidth of about 932 Hz up to about 5273 Hz. But it doesn't have to be in that direction. For a bridge pickup, it can just as well be designed to change from the natural bandwidth of 9073 Hz, or a 57.4 fret-equivalent, downwards in 3-fret steps, or 2-fret steps, or any other number of frets, to lower fret-equivalents, to enhance higher-frequency resonant peaks, and thus enhancing the treble output of the bridge pickup. This can be useful in circuits based upon U.S. Pat. No. 10,380,986 (Baker, 2019), which makes humbucking circuits of matched single-coil pickups, reducing the extra turns often placed on a single-coil bridge pickup to boost the otherwise low output.

TABLE 5
Practical C1 to C11 = Ct in FIG. 5 for typical P = 90
pickup with bandwidths from circuit simulation software,
showing an accuracy of about plus or minus 0.5 fret

| | | Simulated BW | |
|---|---|---|---|
| Cap | Practical Ct(nF) | (Hz) | Practical Fret |
| C1 | 20 | 944 | 18.2 |
| C2 | 15 | 1084 | 20.6 |
| C3 | 10 | 1322 | 24.0 |
| C4 | 6.8 | 1519 | 26.5 |
| C5 | 4.7 | 1900 | 30.3 |
| C6 | 3.3 | 2239 | 33.2 |
| C7 | 2.2 | 2707 | 36.5 |
| C8 | 1.5 | 3217 | 29.4 |
| C9 | 1 | 3823 | 42.4 |
| C10 | 0.68 | 4460 | 45.1 |
| C11 | 0.39 | 5401 | 48.4 |
| Copen | 0 | 9077 | 57.4 |

### A Second Embodiment—Switched Series Ri with a Single Ct

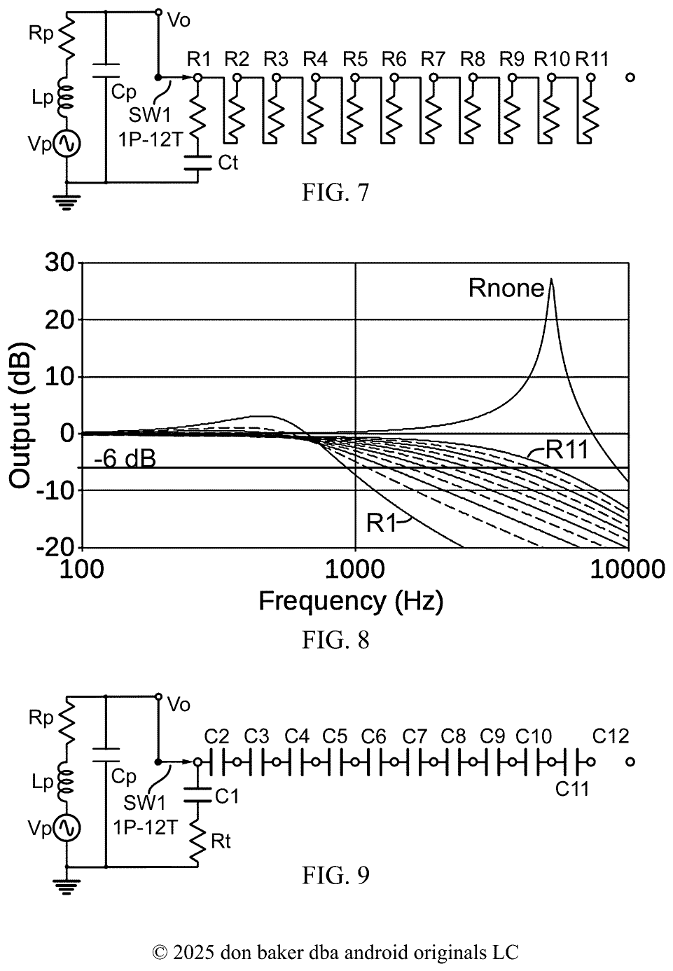

FIG. 7 shows a second embodiment, a pickup as in FIG. 1, with a switched-resistor tone circuit in parallel with it, using a 1-pole, 12-throw rotary or digital switch, a tone capacitor, Ct, and 11 resistors, all set to produce a fret-like log change in output bandwidth. The switch should again be shorting, or make-before-break, to minimize squawking with switch changes. The throw on the left connects the pickup to R1 in series with Ct. For each successive throw, another resistor is added in series with Ct. So the next throw would be (R1+R2) in series with Ct, and the next-to-last throw would be (R1+R2+ . . . +R11) in series with Ct. The last throw would remove Ct from the circuit entirely, leaving the pickup to produce its natural bandwidth. As shown, if the switch is rotary, then the direction of the throws can be either clockwise or counter-clockwise, depending on the musician's preference. The same thing can be programmed for a digital/analog solid state switch circuit.

Let us again take a typical P-90 pickup from Table 3 for the example circuit, with a string-1 18-fret equivalent low frequency bandwidth of 932.25 Hz. Math 3 again produces a value of 19.27 nF for Ct with Rt=0. But the nearest capacitance value in an on-hand capacitor kit is 20 nF. So we have to use that. The math from U.S. patent application Ser. No. 18/906,082 (Baker, 2024) shows that two values of Rt produce that bandwidth frequency for Ct=20 nF, Rt=0 and Rt=5827.1 ohms. The explanation is complex and left for the reader to look up in that prior Patent Application.

Given Lp, Rp, Cp and Ct, Math 6 produces the proper value of Rt to produce the desired bandwidth frequency from Table 1. Again, we take 3-fret steps for 11 values of bandwidth from 932.25 Hz at fret 18 to 5273.6 Hz at fret 48, and leave the last switch position to produce the full natural bandwidth of the pickups. In a spreadsheet, it is convenient to calculate the terms in the square root of Math 6 in 7 terms in 7 columns, with the denominator in an 8th column, and the final calculation in a 9th column. Note that the derivation of Math 6 also involves choosing the correct root of a solution of Math 3 for Rt. This makes the design solution here rather non-obvious, and something which “cannot be encompassed inside the human mind”.

TABLE 6
Solution of Rt from Math 6 for typical P-90 pickup, Ct =
20 nF, and 3-fret steps from fret 18 equivalent bandwidth;
F is bandwidth frequency (Hz); Rt is resistance in ohms;
Rstep is the difference between values of Rt in ohms.

| | | Rt(Math6) | Rstep |
|---|---|---|---|
| Fret | F(Hz) | (ohms) | (ohms) |
| 18.0 | 932.25 | 5827 | 5827 |
| 21.0 | 1108.64 | 13032 | 7205 |
| 24.0 | 1318.4 | 17982 | 4950 |
| 27.0 | 1567.85 | 22717 | 4735 |
| 30.0 | 1864.5 | 27672 | 4955 |
| 33.0 | 2217.28 | 33056 | 5384 |
| 36.0 | 2636.8 | 39005 | 5949 |
| 39.0 | 3135.7 | 45642 | 6636 |
| 42.0 | 3729 | 53146 | 7504 |
| 45.0 | 4434.55 | 61901 | 8755 |
| 48.0 | 5273.6 | 72861 | 10961 |

Table 6 shows the calculations for the tone resistance, Rt (ohms) from Math 6 for a typical P-90 pickup and a tone capacitor of 20 nF, for bandwidth steps in equivalent frets from 18 to 48 in 3-fret steps. The last column shows the resistance steps between values of Rt, which correspond to the values of R1 to R11 in FIG. 7. But we can't really pick those exact values of Rt and Rstep. Say that we have a resistor kit from Amazon which has values of 3900, 4300, 4700, 5100, 5600, 6200, 6800, 7500, 8200, 9100, 10000 and 11000 ohms, which are 5% values. We will have to pick the closest values that fit the steps of Rt. And the first value that we pick for R1 is 5600 ohms. That means that the next value should be close to 13032−5600=7432 ohms. Say that we pick 7500 ohms. Here we have to change the formula for the next value, as shown in Math 8. In other words, one has to add all the previous values of Ri=Rpick, and subtract the sum from the next Rt.

$${Rnext}_{i} = {Rt}_{i} - {\sum }_{j = 1}^{i - 1} {Rpick}_{j} \qquad Math 8$$

TABLE 7
Picks for Ri = R1 to R11 in FIG. 7, with resulting bandwidth
frequency, Fresult (Hz), and equivalent fret, FretResult, using
5% resistor values, showing an accuracy of about plus or minus 0.1 fret

| | Rpick = Ri | Rnext | Rsum | Fresult | |
|---|---|---|---|---|---|
| i | (Ohms) | (Ohms) | (Ohms) | (Hz) | FretResult |
| 1 | 5600 | | 5600 | 929.5 | 17.9 |
| 2 | 7500 | 7432 | 13100 | 1111.1 | 21 |
| 3 | 4700 | 4882 | 17800 | 1309.7 | 23.9 |
| 4 | 5100 | 4917 | 22900 | 1578.3 | 27.1 |
| 5 | 4700 | 4772 | 27600 | 1860 | 30 |
| 6 | 5600 | 5456 | 33200 | 2227.1 | 33.1 |
| 7 | 5600 | 5805 | 38800 | 2621.9 | 35.9 |
| 8 | 6800 | 6842 | 45600 | 3132.5 | 39 |
| 9 | 7500 | 7546 | 53100 | 3725.3 | 42 |
| 10 | 9100 | 8801 | 62200 | 4458.5 | 45.1 |
| 11 | 11000 | 10661 | 73200 | 5297.9 | 48.1 |

Table 7 shows the results for a set of picks of Ri=R1 to R11. The resulting bandwidth frequency, Fresult, is calculated by changing w=2*Pi*F in Math 3 using a spreadsheet Solver tool to get g=½. Then the equivalent fret can be calculated with Math 9 (for a string 1 open fret frequency of 329.6 Hz)

$$FretResult = 12 \frac{log ( Fresult / 329.6 )}{log ( 2 )} \qquad Math 9$$

Other picks are possible, and the picking can be optimized in a software program to get the best overall set of values for Rt. Other resistor kits are possible, and can be even closer, using the standards for 1% resistor values for example, as shown in Table 8, with an improvement in the resulting fret equivalent bandwidths.

TABLE 8
Picks for Ri = R1 to R11 in FIG. 7, with resulting bandwidth frequency,
Fresult (Hz), and equivalent fret, FretResult, using 1% resistor values,
showing and accuracy of about plus 0.1 to minus 0.0 fret

| Switch | Rpick = Ri | Rnext | Rsum | Fresult | |
|---|---|---|---|---|---|
| Position i | (Ohms) | (Ohms) | (Ohms) | (Hz) | FretResult |
| 1 | 5760 | | 5760 | 931.4 | 18 |
| 2 | 7320 | 7272 | 13080 | 1110.4 | 21 |
| 3 | 4990 | 4902 | 18070 | 1322.7 | 24.1 |
| 4 | 4640 | 4647 | 22710 | 1567.5 | 27 |
| 5 | 4990 | 4962 | 27700 | 1866.3 | 30 |
| 6 | 5360 | 5356 | 33060 | 2217.5 | 33 |
| 7 | 5900 | 5945 | 38960 | 2633.5 | 36 |
| 8 | 6650 | 6682 | 45610 | 3133.3 | 39 |
| 9 | 7500 | 7536 | 53110 | 3726.1 | 42 |
| 10 | 8660 | 8791 | 61770 | 4424.1 | 45 |
| 11 | 11000 | 11091 | 72770 | 5267 | 48 |
| 12 | | | (open) | 9073 | 57.4 |

FIG. 8 shows a software circuit simulator output bandwidth curves for the typical P-90 pickup, with the 5% values of Rpick in Table 7, for the circuit in FIG. 7. It also has a line for −6 dB, roughly equal to g=½ in Math 3. Each of the curves shows increased bandwidth from R1=5760 ohms to R11=11,000 ohms, with Rnone=10⁹ ohms, a virtual open circuit. The curves alternate R1 solid, R2 dashes, R3 solid and so on, as the values are switched into the sum by SW1 in FIG. 7, the total resistance shown in the Rsum column in Table 7. The second embodiment is preferred over the fifth emodiment, described below.

TABLE 9
Picks for Ri = R1 to R11 in FIG. 7, with resulting appproximate
Simulated Bandwidth frequency (Hz), and equivalent fret, FretResult,
using 5% resistor values, according to a software circuit simulator
using those values with a typical P = 90 pickup and a 20 nF
tone capacitor, showing an accuracy of about plus or minus 0.2 fret

| Switch | | Simulated | |
|---|---|---|---|
| Position i | Rpick = Ri (Ohms) | Bandwidth (Hz) | FretResult |
| 1 | 5760 | 928 | 17.9 |
| 2 | 7320 | 1103 | 20.9 |
| 3 | 4990 | 1311 | 23.9 |
| 4 | 4640 | 1558 | 26.9 |
| 5 | 4990 | 1852 | 29.9 |
| 6 | 5360 | 2200 | 32.9 |
| 7 | 5900 | 2616 | 35.9 |
| 8 | 6650 | 3108 | 38.8 |
| 9 | 7500 | 3694 | 41.8 |
| 10 | 8660 | 4390 | 44.8 |
| 11 | 11000 | 5218 | 47.8 |
| 12 | 10⁹ | 9067 | 57.4 |

Table 9 shows the approximate bandwidth frequency, Fresult (Hz), using the 5% resistor values for Rpick=Ri in Table 7, using circuit simulation software. The frequency is eyeballed from a printed table that does not hit-6 dB every time, and the math in the software circuit simulator is probably less precise than the spreadsheet used to calculate Table 7. So the resulting FretResult numbers in Table 8 are a bit off, but for the most part are close to 3 equivalent frets apart in bandwidth.

### A Third Embodiment, Switched Series Ci with a Single Optional Rt

FIG. 9 shows an example of a third embodiment, where 1-pole, 12-throw switch connects the pickup to the nodes of a capacitance ladders, comprised of capacitors C1 to C12, connected in series on the throws of the switch, with a single optional tone resistor, Rt, all set to produce a fret-like log change in output bandwidth. In this example, Rt=0 Ohms. The last capacitor, C12, is an optional open circuit, to allow the pickup the full range of its natural bandwidth. The effective capacitance of the switched series capacitors is C1,i, as shown in Math 10, where I is the switch throw from 1 to 11, and C1,i is the series capacitance from C1 to Ci on the ladder. Math 11 shows how to pick the next value for Ci+1, given the design value for i+1 and the last total series capacitance, C1,i.

$${C}_{1 , i} = \frac{1}{{\sum }_{j = 1}^{i} \frac{1}{{C}_{j}}} , \qquad Math 10$$

i=the number of of the throw, 2 or more

$$Cnext ( i + 1 ) = \frac{{C}_{1 , i} \cdot Cdesign ( i + 1 )}{{C}_{1 , i} - Cdesign ( i + 1 )} \qquad Math 11$$

Let us use the same design values for C1,i as the Design Ct (nF) in column 4 of Table 4, for a P-90 pickup with 3-fret equivalent bandwidth steps from fret 18, about 932.25 Hz to 48, about 5273.3 Hz. In Table 10, the avialable capacitor kit value of C1,1=20 nF is picked first and is set as Cnext. That also makes the first value of C1, 1=20 nF by Math 10. The next value of Cnext, 14.03 nF (to be approximated by the next Cpick value) is calculated from Math 11, using the last Cp-series value, 20 nF, and the next C-design value, 13.73 nF. This comes out to be 43.83 nF. The closest capacitor kit value is 47 nF=Cpick, which produces a Cp-series value of 14.03 nF instead of the design value of 13.73 nF. This progresses as shown in Table 10, until all the needed series capacitor values are picked to produce the approximate total capacitance of the series at each switch throw. The Bandwidth is calculated from Math 2, and the fret equivalent bandwidth is calculated from Math 9.

TABLE 10
Example third embodiment design of switch series capacitors,
Cpick (nF), to combine in series to approximate the design
values, C-design (nF) for a P-90 pickup with bandwidth freq
equivalents from 18 (932.25 Hz) to 48 (5273.6 Hz), showing
an accuracy of about plus 0.1 fret to plus 0.6 fret

| Design | C-design | Cpick | Cnext | C1, i | BW | Equiv |
|---|---|---|---|---|---|---|
| Fret | (nF) | (nF) | (nF) | (nF) | (Hz) | Fret |
| 18 | 19.27 | 20 | 20.00 | 20.00 | 942.0 | 18.2 |
| 21 | 13.73 | 47 | 43.83 | 14.03 | 1119.7 | 21.2 |
| 24 | 9.73 | 33 | 31.80 | 9.84 | 1330.3 | 24.2 |
| 27 | 6.86 | 22 | 22.68 | 6.80 | 1591.1 | 27.3 |
| 30 | 4.81 | 15 | 16.47 | 4.68 | 1903.6 | 30.4 |
| 33 | 3.35 | 10 | 11.82 | 3.19 | 2281.7 | 33.5 |
| 36 | 2.31 | 6.8 | 8.43 | 2.17 | 2724.3 | 36.6 |
| 39 | 1.58 | 4.7 | 5.75 | 1.48 | 3226.4 | 39.5 |
| 42 | 1.05 | 3.3 | 3.62 | 1.02 | 3778.4 | 42.2 |
| 45 | 0.68 | 2 | 2.04 | 0.68 | 4451.9 | 45.1 |
| 48 | 0.42 | 1 | 1.11 | 0.40 | 5345.3 | 48.2 |

In comparing Table 10 to Table 4, this embodiment has a slightly smaller RMS and Sum-squared error with the designed equivalent fret bandwidth, so it could be considered preferrable. But it also uses larger capacitors to get nearly the same result. So which one is preferrable will be an engineering decision, as to which design is more efficient in cost and space. The optional tone resistor, Rt, in FIG. 9 will not affect the results too much if its value is kept on the order of the pickup resistance, Rp.

### A Fourth Embodiment, Switched Ri+Ci

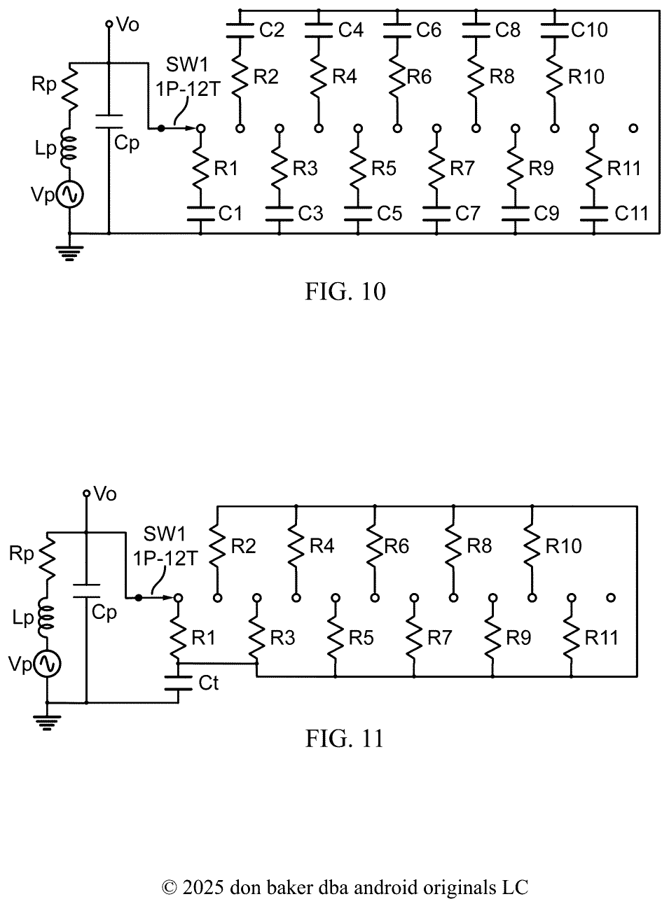

FIG. 10 shows an example of a fourth embodiment, where 1-pole, 12-throw switch connects the pickup to 11 different versions of Rt in series with Ct, labeled Ri and Ci, I=1 to 11, all set to produce a fret-like log change in output bandwidth. The 12th throw is an open circuit, allowing the pickup its full natural bandwidth. FIG. 5 shows the first embodiment, with a single low value of Rt and capacitors, Ci, switched in series with it. FIG. 6 shows the results, with resonant peaks increasing in height with bandwidth. It a resistor is placed in series with each capacitor, then the height of each of those peaks can be manipulated. However the math would be very complicated, and is beyond the current skills of this inventor. Some software circuit simulation shows that the bandwidth and the frequency of the resonant peak also shift with added series resistance, Ri. That makes three parameters, bandwidth, resonant peak frequency and resonant peak height, that shift with the two values of Ri and Ci at each throw. So it is likely that only two of those parameters can be controlled by the two values of Ri and Ci, letting the third fall where it may.

Adding a series resistor, Ri, to Ci can only reduce the height of the resonant peak, not increase it. So FIG. 6 shows the upper limits of those peaks. The human ear responds differently to different pure tones and adjacent multiple tones, tending to peak at frequencies above 1000 Hz. A-weighting and ITU-R 468 weighting, among others, have been used to express this. Based on FIG. 6, it is reasonable to suspect that adding series resistors could produce a very slight bass boost at low bandwidths set by switch SW1, and a fairly high treble boost as high bandwidths set by switch SW1, with a flattening of the peaks (if desired) where human hearing is most sensitive. But the math, as shown by Maths 2, 3 and 6, is already complicated. And so is the human ear.

Say that one could specify a desired envelope of resonant peak height as a function of log bandwidth, sitting lower than that indicated by FIG. 6. This would of course be different for every pickup, and need to be calculated either for individual pickups or by pickup lots of sufficiently similar manufacture. One possible method would be to set up a separate software circuit simulation for each set of (Ri, Ci), then use a mathematical optimization method like simulated annealing to vary each set of (Ri, Ci) in simulations, until the results both fit the desired envelope and the desired steps in bandwidth. This requires far more effort in R&D than can be done here and now. It must be left to other investigators, and may or may not prove fruitful.

### A Fifth Embodiment, Switched Ri with a Single Ct

FIG. 11 shows an example of a fifth embodiment, where 1-pole, 12-throw switch connects the pickup to 11 different versions of Rt, labeled Ri, I=1 to 11, in series with a single Ct, with the values of Ri set to produce a fret-like log change in output bandwidth. The 12^{th} throw is an open circuit, allowing the pickup its full natural bandwidth. For a typical P-90 pickup In this case, the values of Ri would follow the third column of Table 6, instead of the fourth column. Table 11 shows the usual 3-fret steps used with the other embodiments for a typical P-90 pickup with Ct=20 nF, using the nearest 1% standard values of resistor for the switched resistors, Ri. The results are within plus or minus 0.2 frets. The FretResult column is not quite as good as for the second embodiment results in Table 8, making this circuit less preferred.

TABLE 11
An example of the fifth embodiment for a tyupical P-90
pickup, using 3-fret bandwidth steps and 1% resistor
values with Ct = 20 nF; the FretResult values
are not quite as good as for the second embodiment.

| | Bandwidth | | | Fresult | |
|---|---|---|---|---|---|
| Fret | (Hz) | Rt(Math6) | Ri (Ohms) | (Hz) | FretResult |
| 18.0 | 932.25 | 5827 | 5760 | 931.4 | 18 |
| 21.0 | 1108.64 | 13032 | 13000 | 1107.5 | 21 |
| 24.0 | 1318.4 | 17982 | 17800 | 1309.7 | 23.9 |
| 27.0 | 1567.85 | 22717 | 22600 | 1561.3 | 26.9 |
| 30.0 | 1864.5 | 27672 | 27400 | 1847.5 | 29.8 |
| 33.0 | 2217.28 | 33056 | 33200 | 2227.1 | 33.1 |
| 36.0 | 2636.8 | 39005 | 39200 | 2651 | 36.1 |
| 39.0 | 3135.7 | 45642 | 45300 | 3109.3 | 38.9 |
| 42.0 | 3729 | 53146 | 53600 | 3765.5 | 42.2 |
| 45.0 | 4434.55 | 61901 | 61900 | 4434.5 | 45 |
| 48.0 | 5273.6 | 72861 | 73200 | 5297.9 | 48.1 |

### PREFERRED EMBODIMENTS

Embodiments 1 and 3 tend to emphasize the resonant peaks that the effective values of Ct produce with the pickups used, thus emphasizing the higher frequencies. They might thus be more useful for bridge or middle pickups than for neck pickups. Embodiments 2 and 5 tend to suppress the resonant peaks, especially at the lower bandwidths, and might thus be more useful for neck pickups than for middle or bridge.

Embodiments 1 and 3, primarily using switched capacitors, have very similar results, with embodiment 3 (FIG. 9) being slightly better in fitting the fret-step bandwidth changes. As noted before, considerations of engineering trade-offs may determine which is preferred over the other. Embodiment 2 and 5, primarily using switched resistances, have more significant differences in results, with Embodiment 2 (FIG. 7) being better and preferred. Embodiments 2 and 3, with the switch throws running along a series of resistors or capacitors are better than their counterparts, because the method of picking the next resistor or capacitor tends to be more corrective to the total value than simply switching between different values, as in embodiments 1 and 5. Embodiment 4 requires more R&D, and cannot be fully evaluated at this time.

Note that in each of the embodiments, all the capacitors are necessary to the limitation of output bandwidth, but not all of the resistors, some of which may be zero in value, depending on the design.

### Comments on Prior Art, Obviousness, Abstractions and Natural Law

Everything is obvious once you see how it works. And personally, I object to the ideal of a Patent Examiner deciding in the Examiner's head what an engineer or inventor in the past thought in his or her head. It suggests concepts of time-travel, telepathy and hearsay normally precluded from legal arguments. Just because something is patently simple enough in concept that perhaps someone should have thought of it before doesn't mean that anyone did. E equals M times C squared is just that “simple”. Hence the term, “first to file”, which is currently Patent Law.

The human ear is known to be logarithmic in both frequency and amplitude. Therefore it follows that in order for a tone control to seem to change the bandwidth of a pickup output evenly, it should change the bandwidth logarithmically with position of a tone control element. Previously, this has meant a capacitor, Ctone, in series with a potentiometer, Ptone, of linear or “audio” taper to form a low-pass bandwidth filter at the output of an electric guitar or guitar pickup, with the Ptone+Ctone series circuit across the output.

Fender's tone control patent (U.S. Pat. No. 2,784,631, 1957) mentions “tone control potentiometer resistance 29 and condenser 30”, col 2, line 48. In the 67 years since, that has been the standard for commercial electric guitars, no matter how badly it works with commercially available linear and audio taper pots. U.S. Non-Provisional Patent Application (NPPA) 18/906,082 (Baker, filed 2024 Oct. 3) shows that in most cases, there can be areas of pot rotation where there is little change in perceived tone (timbre), interspersed with often shorter areas where the tone changes rapidly with pot rotation. There does not seem to be any commercial standard pot taper in which a simple R-C tone circuit can change the apparent bandwidth of the pickup output, or “tone”, logarithmically with pot rotation. The sole exception may the use of a linear pot over the first part of the expansion of bandwidth with certain pickups.

So, if the standard method for tone control works so poorly, why has no one apparently done any better in nearly 68 years? Inertia is one answer. It is possible that someone may have solved the problem before and ordered special taper pots, like those in NPPA 18/906,082. But if so, it seems to have been a trade secret, not a patented invention. As such, it would not be “first to file”. And even if such a special taper pot had been made and used in a commercial product, no one to my knowledge has publicly disclosed how to make it work for all the types of pickups shown in Table 3. Nor do we seem to have any search engine good enough to show if this has been published anytime in the last 67 years, in all of the existing journal and magazine articles, conference presentations, science fair projects, theses and dissertations (excluding fantasy and science fiction).

Someone once wrote on IPWatchDog_dot_com that if someone can throw an invention at you and hit you in the head, it's not an abstraction. I submit that if the switches designed here (and used in one of my working prototype guitars) were thrown hard enough, they could draw blood.

Then there's the issue of using math, the essential language of Engineering, in claims to describe how such a tone switch is designed. In another NPPA, I once put decimal numbers and mathematical ellipses into Claims and had the Examiner reject them on the basis of having “too many periods”.

You don't hear that a lot in Engineering School.

In the USPTO and subsequent Courts, Math seems to suffer from guilt by association with “Natural Law” or “a Law of Nature”, which is not patentable. Fortunately, there is a scientific way to discern what is and is not a natural law. It's called the Buckingham Pi Theorum. It can essentially define a natural law by finding the dimensionless product of all the physical parameters of a natural phenomenon. You must check me on that, because it's been over 20 years since I last used it. But it applies to all natural laws, from heat flow, to gravity, to the spring law, to E equals M times C squared.

I submit that if you can't express or derive a mathematical relationship with the Buckingham Pi Theorum, then it's not a natural law, and thus not excluded from describing inventions.

According to the October 2019 Update to 2019 Revised Patent Subject Matter Eligibiligy Guidance (2019 PEG):

“When determining whether a claim recites a mathematical concept (i.e., mathematical relationships, mathematical formulas or equations, and mathematical calculations), examiners should consider whether the claim recites a mathematical concept or merely includes limitations that are based on or involve a mathematical concept. A claim does not recite a mathematical concept (i.e., the claim limitations do not fall within the mathematical concept grouping), if it is only based on or involves a mathematical concept.12 For example, a limitation that is merely based on or involves a mathematical concept described in the specification may not be sufficient to fall into this grouping, provided the mathematical concept itself is not recited in the claim.”

Even this poses a difficult to impossible engineering dilemma. It seems to say that one cannot even reference in the Claim the notated “Math xx” used in the specification to express the limitation. Just how does one express a limitation based on a mathematical concept without adequately describing or identifying the math concept itself? It would be like trying to describe a color in scientific or engineering terms without specifying the exact frequencies and intensities of light which compose it. It becomes like a description of how many dead lawyers can dance on the head of a pin. For in the case of lawyers, the Medieval theological argument about dancing angels is simply inappropriate.

Mathematics is a fundamentally an abstract “mental process”. Yet later in the October 2019 PEG Update, it states: “Claims do not recite a mental process when they do not contain limitations that can practically be performed in the human mind, for instance when the human mind is not equipped to perform the claim limitations.”

This would seem to be self-contradictory. Even Ohm's Law, a natural law with only three parameters, E, I and R, can be quite difficult to perform in one's head. Hence the invention of slide rules. Math 6 in this document shows that a very simple circuit (FIG. 3), expressed with only six physical parameters, Lp, Rp, Cp, Rt, Ct, and w, produces a calculation that requires a spreadsheet on a computer with multiple columns. Where is the human brain that can perform it without such help? Even the much simpler Math 5 would be cumbersome on a digital calculator.

The invention disclosed here seems simple enough in both circuit and physical design. Gretsch Guitars has offered a 2-way or 3-way switch, commonly called a “mud switch”, which offers two different tone capacitors, or none. It might seem obvious to offer a switch that offers more poles for more resistors or capacitors or both. But the complexity of the math, and using it to pick the values of the resistors and/or capacitors to change the bandwidth in fret-like logarithmic steps makes it non-obvious. And what's more, it is cost-effective and works much better than tone pots. Yet how can one write claims to make that point, and describe those mathematically-based limitations, when even to mention the math is considered USPTO/MPEP heresy?—Thereby invoking Death By Too Many Periods.

The Guidance does not give us much guidance on that point. It just hamstrings adequate engineering descriptions with yet more legal language, making them more complicated than Engineering School ever invisioned.

How is this good for engineering innovation?

1. A switching guitar pickup tone circuit in five embodiments, comprising of a 1-pole, or 2 or more throw switch, mechanical or solid state, preferably an instantaneous or make before break or shorting switch, to place different resistor-capacitor series circuits in parallel with a guitar or guitar pickup output, the output considered to be a two terminal device with designated first and second output terminals, either of which can be considered the high terminal with the other considered low, with each active throw of the switch changing the resistor-capacitor series circuit, which thus limits and changes the bandwidth of said output in fret like logarithmic steps with each throw of the switch, with an optional inactive switch throw at one end of the throw sequence which places no equivalent resistor-capacitor series circuit in parallel with the guitar or pickup output, to wit:
a. a first embodiment with each throw of said switch connecting to two or more separate tone capacitors, each tone capacitor connected between a switch throw and a common connection with all the other tone capacitors, the tone capacitor values chosen to produce fret-like logarithmic steps in output bandwidth, the pole of the switch connected to a first output terminal, or to an optional resistor connected to the first output terminal, the common connection with all the tone capacitors connected either to a second output terminal, or to an optional resistor connected to a second output terminal, when the optional resistor is not connected to the first output terminal, and
b. a second embodiment with a 1-pole switch of 2 or more throws, each throw connecting to a separate node in a set of resistors connected in series, all but one of the resistors connected between the throws of the switch, the remaining resistor connected by its first terminal to a throw an an end of the sequence of throws, with its second terminal connected to a first terminal of a single tone capacitor, the pole of the switch being connected to a first output terminal and the second terminal of the single tone capacitor being connected to the second output terminal, such that the throws of the switch advancing away from the single tone capacitor increase the resistance in series with it to produce fret-like logarithmic steps in output bandwidth, and
c. a third embodiment, similar in circuit topology to the second embodiment, with the single tone capacitor of the second embodiment being replaced by an optional single tone resistor in the third embodiment, and the series of resistors in the second embodiment being replaced by a series of capacitors in the third embodiment, such that as the switch throws advance away from the optional single tone resistor, the effective tone capacitance in series with said optional tone resistor decreases to produce fret-like logarithmic steps in output bandwidth, and
d. a fourth embodiment, wherein each active throw connects to a different series combination of tone resistor, which tone resistor may be a short circuit, in series with a tone capacitor, such that the advance of throws changes the output bandwidth in fret-like logarithmic steps, and
e. a fifth embodiment, similar in circuit topology to the first embodiment, with the single tone resistor in the first embodiment being replaced by a single tone capacitor in the fifth embodiment, and the tone capacitors in the first embodiment being replaced by tone resistors in the fifth embodiment, such that as switch throws advance away from the single tone resistor, the output bandwidth advances in fret-like logarithmic steps.

2. A switching guitar pickup tone circuit placed across an individual electric guitar electromagnetic pickup, or more commonly guitar pickup or pickup, said guitar having a bridge and a neck with one or more of said pickups positioned in between, said pickup commonly having only two terminals, said switching guitar pickup tone circuit intended to change the timbre of said, also commonly called tone by guitarists, of said pickups, by modifying the higher frequency output of said pickup, also known as a pickup-circuit combination, comprising of:
a. a switch, electromechanical or solid-state, preferably a make-before-break, also known as a shorting switch, in the case of an electromechanical switch, and preferably instantaneous in the case of a solid-state switch, with one pole and two or more throws, preferably 10 to 12 throws, preferably connected to an individual guitar pickup, and,
b. each throw of said switch placing a different series resistance-capacitance (RC) values across said pickup in parallel with said pickup, such that the upper frequency range of the output of said pickup is modified as changes in the low-pass frequency and/or peak frequency of said pickup-circuit combination with changes in switch position, preferably as monotonic log changes.

3. An embodiment of said switching guitar pickup tone circuit, as recited in claim 2, as shown in FIG. 10, in which each throw has an individual resistor in series with an individual capacitor.

4. An embodiment of said switching guitar pickup tone circuit, as recited in claim 2, as shown in FIG. 7, being preferred for pickups closer to the guitar neck, in which said switch throws connect to a set of resistors connected in series, said resistor series in series with a single capacitor, such that the resistance of said RC value changes but the capacitance remains the same.

5. A less-preferred embodiment of said switching guitar pickup tone circuit, as recited in claim 2, as shown in FIG. 11, in which said switch throws connect to a set of resistors, each of which is connected by a throw to a single capacitor.

6. An embodiment of said switching guitar pickup tone circuit, as recited in claim 2, as shown in FIG. 9, being preferred for pickups closer to the guitar bridge, in which said switch throws connect to a set capacitors connected in series, said capacitor series in series with a single resistor, such that the capacitance of said RC value changes, but the resistance remains the same.

7. A less-preferred embodiment of said switching guitar pickup tone circuit, as recited in claim 2, as shown in FIG. 5, in which said switch throws connect to a set of capacitors, each of which is connected by a throw to a single resistor.

8. An embodiment of said switching guitar pickup circuit, as recited in claim 6, in which the resistance is zero, preferably used with said pickups closest to said bridge.

9. A less-preferred embodiment of said switching guitar pickup circuit, as recited in claim 7, in which the resistance is zero, preferably used with said pickups closest to said bridge.
